(19) United States
(12) Patent Application Publication
(10) Pub. No.: US 2009/0103300 A1
(43) Pub. Date: Apr. 23, 2009

(54) LAMP STRUCTURE WITH LOW TEMPERATURE FEATURE

(76) Inventor: Chia-Cheng CHANG, Taipei (TW)

Correspondence Address: Muncy, Geissler, Olds & Lowe, PLLC, P.O. BOX 1364, FAIRFAX, VA, 22038-1364, US

(21) Appl. No.: 12/343,165

(22) Filed: Dec. 23, 2008

(30) Foreign Application Priority Data
Feb. 1, 2008 (TW) 097103836

(51) Int. Cl. F21V 7/00; F21V 15/01; F21K 7/00

(52) U.S. Cl. 362/249.02; 362/362; 362/296.01

(57) ABSTRACT

A fluorescent lamp holder combination device includes a main lamp holder and an auxiliary lamp holder set, which is provided with an auxiliary lamp holder. The main lamp holder is internally configured with a multifunction ballast, which is electrically connected to a conducting portion. Each of the conducting portions is electrically connected to a connecting portion of each of the auxiliary lamp holders by means of a set of conducting cables, thereby enabling parallel connection between each of the auxiliary lamp holders using the single multifunction ballast, and achieving the effectiveness to enable the single multifunction ballast to provide stable rectification and energy saving for the auxiliary lamp holders. Furthermore, a starting capacitor and current-limiting inductor can be disposed within each of the auxiliary lamp holders, thereby reducing use-cost of the set of conducting cables while facilitating maintenance of the starting capacitors and the current-limiting inductors.

### BACKGROUND OF THE INVENTION

(a) Field of the Invention

The present invention relates to a lamp structure with low temperature feature, particularly for one having lamp body been founded alloy of various metals by fusing in multi-stage heating process for effectively absorbing and dissipating the thermal energy generated therein so as to effectively maintain the normal operating ambient temperature in the lamp.

(b) Description of the Prior Art

As greenhouse effects due to global warming result being more obvious, the frequency of world climatic abnormality has already soared and worsened year by year. Accordingly, every country currently has begun to tackle such abnormal phenomenon. Other than reducing the production of the carbon dioxide (CO2), the research and development of various alternative energy source, regenerated energy, eco-friendly energy source are actively undertaking and increasing annually. Additionally, how to reduce high temperature heat generated by lamps becomes the critical issue to be urgently overcome at present too. The structure of the current conventional lamps is mostly made of metal body with primary illuminating device of traditional bulb, which is apt to produce the high temperature heat while lighting though it can achieve the goal of road lighting. The high temperature heat generated thereof can be partly absorbed by the metal body, but hardly to be dissipated out effectively so that the high-temperature state of the metal body will last for a certain time even lamp being turned off. Thus, there is no benefit in fact to the global warming situation.

So, in order to solve issue described above, most countries all over the world still strive to declare and guide people to reduce the service time of the lamps currently such as blackout schedule of Paris tower and convenience stores, etc for overcoming the high temperature heat generated by the lamps. But the blackout method aforesaid is not a good way because the lamps are mainly used for the illumination. Thus, the conventional lamps, which still exists some drawbacks, at present is indeed not a good contrivance for being unable to overcome the issue on the heat source effectively. In view of the facts and drawbacks with the conventional lamps, the inventor of the present invention has undertaken painstakingly researching and developing study fro many years to eagerly improve lamp function and address the foregoing issue. Eventually, the lamp structure with low temperature feature of the present invention is successfully developed.

### SUMMARY OF THE INVENTION

The lamp structure with low temperature feature for the present invention comprises a lamp body, an illuminating part, a heat sink, a reflector, a frame cover and a fixing plate, wherein said lamp body is a founded alloy of various metals by fusing in multi-stage heating process for effectively absorbing and dissipating the thermal energy generated therein; said illuminating part, which is connected to the lamp body, includes plural light emitting diode (LED) chips to achieve the required illuminating luminance and significantly decrease the thermal energy generated therein as well as effectively prolong the service life thereof; said heat sink is firmly integrated at the base of the illuminating part mutually for effectively conducting the thermal energy to lamp body; said reflector, which is made of metal preferably, is disposed over the illuminating part with extended cover area to promote the illuminating range and angle; said frame cover, which is made of potassium glass with impact-resistant and refractory properties for lengthening the service life, is disposed around the peripheral of the illuminating part and reflector for protecting purpose; and said fixing plate is disposed over the outer rim of the frame cover for securely fixing all the components aforesaid with the lamp body to achieve the primary object in illuminating effect of integral normal function.

For successfully achieving the decreasing effect of temperature via absorption of thermal energy, the fabricating process for the lamp body is founded by “fusing method in multi-stage heating process” of various metals including silicon (Si), iron (Fe), copper (Cu), manganese (Mn), molybdenum (Mo), chromium (Cr), nickel (Ni), zinc (Zn), titanium (Ti), tin (Sn) and aluminum (Al).

The next objective of the present invention is to provide a lamp structure with low temperature feature with illuminating part in assemble of plural light emitting diode (LED) chips so that not only the illuminating effect can be promoted but also the generating heat by conventional lamp can be relatively reduced to achieve the environment protective effect.

The other objective of the present invention is to provide a lamp structure with low temperature feature with frame cover being made of potassium glass with impact-resistant and refractory properties.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is the perspective exploded view of the lamp structure with low temperature feature for the present invention.

FIG. 2 is the perspective combinational view of the lamp structure with low temperature feature for the present invention.

FIG. 3 is the perspective combinational view of the lamp structure with low temperature feature from the other view angle for the present invention.

FIG. 4A is the temperature testing figure of still not turning on yet the lamp structure with low temperature feature for the present invention.

FIG. 4B is the temperature testing data of still not turning on yet the lamp structure with low temperature feature” for the present invention.

FIG. 5A is the temperature testing figure of 30 minutes after turning on the lamp structure with low temperature feature for the present invention.

FIG. 5B is the temperature testing data of 30 minutes after turning on the lamp structure with low temperature feature for the present invention.

FIG. 6A is the temperature testing figure of 60 minutes after turning on the lamp structure with low temperature feature for the present invention.

FIG. 6B is the temperature testing data of 60 minutes after turning on the lamp structure with low temperature feature for the present invention.

### DETAILED DESCRIPTION OF THE PREFERRED EMBODIMENTS

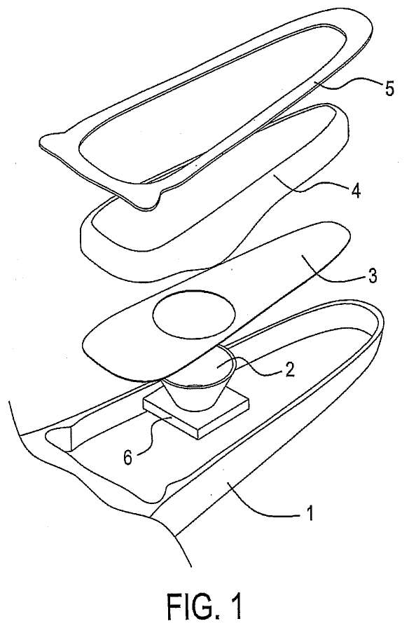

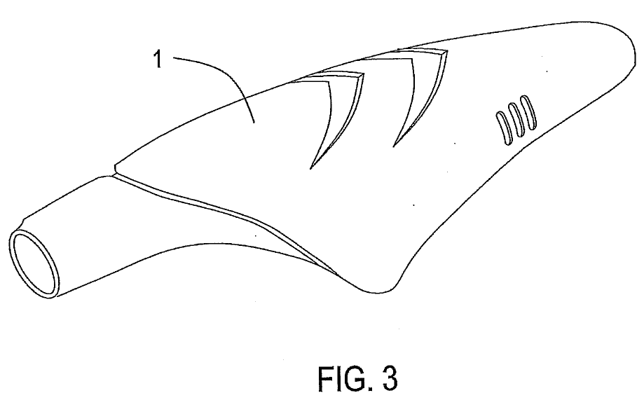

Please refer to the FIGS. 1 through 3, which are the perspective exploded and combinational views of the lamp structure with low temperature feature for the present invention. The lamp structure with low temperature feature comprises a lamp body 1, an illuminating part 2, a heat sink 6, a reflector 3, a frame cover 4 and a fixing plate 5, wherein said lamp body 1 is a founded alloy of various metals by fusing in multi-stage heating process for effectively absorbing and dissipating the thermal energy generated by the illuminating part 2 so as to effectively maintain the normal operating ambient temperature in the lamp; said illuminating part 2, which is connected to the lamp body 1, includes plural LED chips to achieve the required illuminating luminance and significantly decrease the thermal energy generated therein as well as effectively prolong the service life thereof; said heat sink 6 is firmly integrated at the base of the illuminating part 2 mutually for effectively dissipating the thermal energy via lamp body 1 by conducting heat therefrom; said reflector 3, which is made of metal preferably, is disposed over the illuminating part 2 with extended cover area to promote the illuminating range and angle; said frame cover 4, which is made of potassium glass with impact-resistant and refractory properties for lengthening the service life, is disposed around the peripheral of the illuminating part 2 and reflector 3 for protecting purpose; and said fixing plate 5 is disposed over the outer rim of the frame cover 4 for securely fixing all the components aforesaid with the lamp body 1 to achieve the illuminating purpose of integral normal function.

For successfully achieving the decreasing effect of temperature via absorption of thermal energy, the fabricating process for the (lamp body 1) is founded by fusing method in multi-stage heating process of various metals including silicon (Si), iron (Fe), copper (Cu), manganese (Mn), molybdenum (Mo), chromium (Cr), nickel (Ni), zinc (Zn), titanium (Ti), tin (Sn) and aluminum (Al), wherein, by means of the different melting points and flash points for various metals, the procedure step of the fusing method in multi-stage heating process is that firstly fuse the metal of high melting point by high temperature heating process, then lower the temperature stage by stage and put metal of corresponding melting point orderly for fusing phase by phase, finally found the alloy of all metals put by lowest temperature fusion. Thereby, the heat dissipating effect of the final product will not be deteriorated because the metals of lower melting points are prevented from combustion in the high temperature heating process.

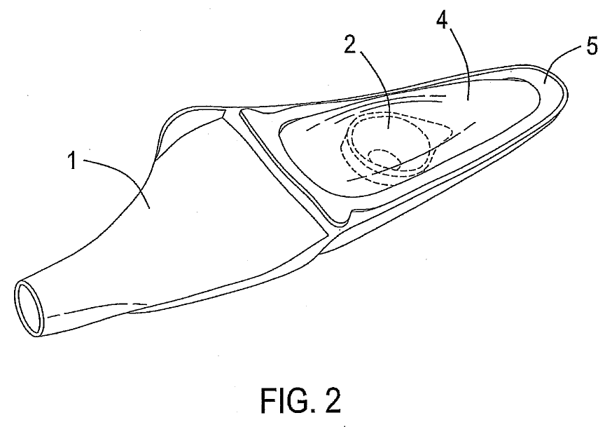

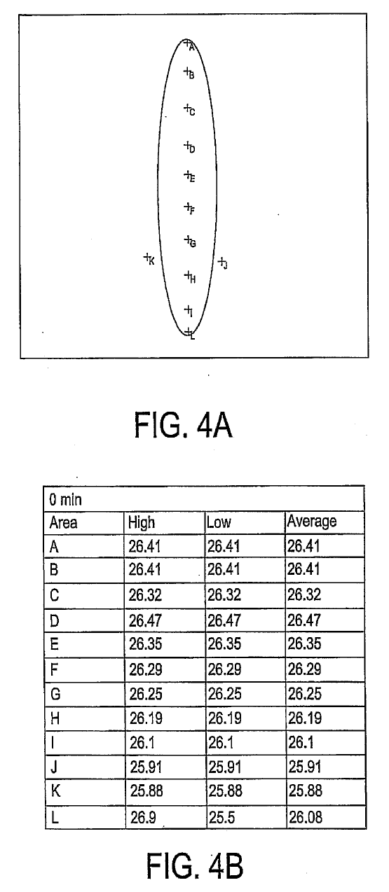

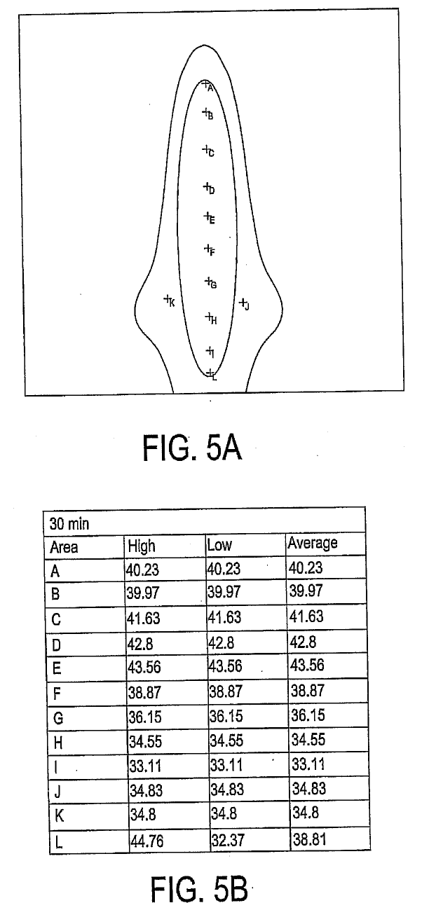

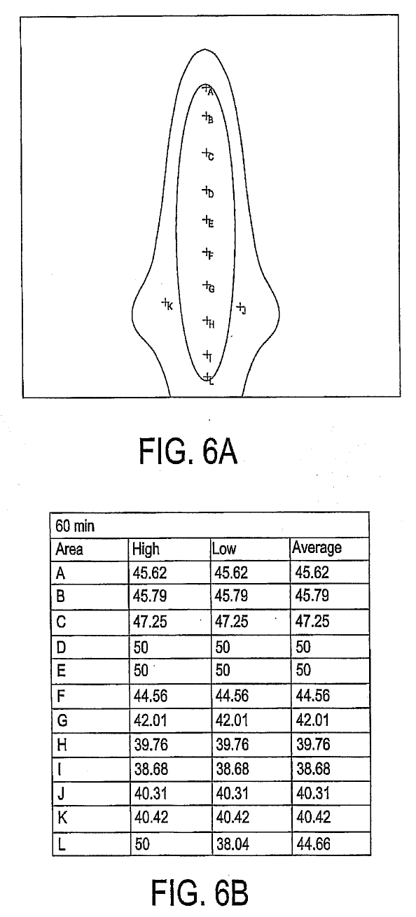

Please refer to FIGS. 4A through 6B, which are the temperature testing figures and data of still not turning on yet, 30 minutes after turning on and 60 minutes after turning on the lamp product for the present invention performed by the commissioned Industrial Technology Research Institute of Taiwan, R.O.C (called ITRI Taiwan for short). From the temperature testing figures, it is obvious that the divergent profile of temperature decreases outwardly form the illuminating part 2 (see FIGS. 1 through 2) such that the lamp body 1 (see FIGS. 1 through 3) achieves the evenly heat dissipating effect.

The temperature testing data show that the averaged temperature data for testing area E of peak temperature in still not turning on yet the lamp and 30 minutes after turning on the lamp in starting normal operation as well as 60 minutes after turning on the lamp in continual normal operation are 26.35° C., 43.56° C., and 50° C. respectively with temperature increment from 30 minutes after turning on and 60 minutes after turning on the lamp being 6.44° C. (50° C.−43.56° C.=6.44° C.). For other testing areas such as A˜D and F˜L, the averaged temperature increment from 30 minutes after turning on and 60 minutes after turning on” the lamp is only 5° C. approximately. From the temperature testing data shown above, the temperature increment for the lamp body 1 (see FIGS. 1 through 3) of the present invention under normal long terms operation is slight in slow manner, which not only successfully achieves the heat dissipating effect but also avoid the lamp body from harmful scalding result.

The detailed description heretofore is only the concrete disclosure in one of the exemplary embodiment for the present invention, which is not intended to limit the range of the claims for the present invention. Therefore, any equivalent embodiment and change or alternation, which does not depart from the technological spirit or nature of the present invention, should be reckoned within the claim scope of the present invention. In conclusion, the contrivance of the present invention not only has originating design on the morphological shape but also has added some useful functions on the conventional lamp that the present invention does really possesses innovative novelty beyond the obviousness of the prior arts with practical usage, which meets the basic stipulated criterion of the patentability. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A lamp structure with low temperature feature comprises a lamp body of founded alloy in various metals by fusing in multi-stage heating process, an illuminating part being connected to the lamp body and a frame cover being disposed around the peripheral of the illuminating part.

2. The lamp structure with low temperature feature according to claim 1, wherein the fabricating process for the lamp body is founded by fusing method in multi-stage heating process of various metals including silicon (Si), iron (Fe), copper (Cu), manganese (Mn), molybdenum (Mo), chromium (Cr), nickel (Ni), zinc (Zn), titanium (Ti), tin (Sn) and aluminum (Al), wherein, firstly fuse the metal of high melting point by high temperature heating process, then lower the temperature stage by stage and put metal of corresponding melting point orderly for fusing phase by phase, finally found the alloy of all metals put by lowest temperature fusion.

3. The lamp structure with low temperature feature according to claim 1, wherein said illuminating part is an assembly of plural light emitting diode (LED) chips.

4. The lamp structure with low temperature feature according to claim 1, wherein a reflector is disposed over the illuminating part with extended cover area to promote the illuminating range and angle.

5. The lamp structure with low temperature feature according to claim 4, wherein the reflector is made of metal material.

6. The lamp structure with low temperature feature according to claim 1, wherein the frame cover is made of potassium glass with impact-resistant and refractory properties.

7. The lamp structure with low temperature feature according to claim 1, wherein a fixing plate is disposed over the outer rim of the frame cover for securely fixing the frame cover with the lamp body.
